(19) United States
(12) Patent Application Publication
(10) Pub. No.: US 2003/0197872 A1
(43) Pub. Date: Oct. 23, 2003

(54) Scatterometric measurement of undercut multi-layer diffracting signatures

(76) Inventors: Michael E. Littau, Albuquerque, NM (US); Christopher J. Raymond, Albuquerque, NM (US)

Correspondence Address: PEACOCK MYERS AND ADAMS P C, P O BOX 26927, ALBUQUERQUE, NM, 871256927

(21) Appl. No.: 10/417,996

(22) Filed: Apr. 16, 2003

Related U.S. Application Data
(60) Provisional application No. 60/373,487, filed on Apr. 17, 2002.

(51) Int. Cl. G01B 11/14

(52) U.S. Cl. 356/625

(57) ABSTRACT

Methods for metrology of undercut multi-layer diffracting structures, utilizing diffraction signature analysis obtained by means of a radiation-based tool, wherein simulated diffraction signals are generated based on models of undercut multi-layer structures. In one method, comparison to a library is employed. In another method, regression analysis is employed. The undercut parameters, including critical dimension and materials factors, can be altered in the models.

### CROSS-REFERENCE TO RELATED APPLICATIONS

This application claims the benefit of the filing of U.S. Provisional Patent Application Serial No. 60/373,487, entitled Measurement of Undercut Diffraction Grating Structures, filed on Apr. 17, 2002, and the specification thereof is incorporated herein by reference.

### BACKGROUND OF THE INVENTION

1. Field of the Invention (Technical Field)

The present invention relates to metrology and process control in manufacturing of semiconductor and other thin film media, including hard drive media, and more particular to model patterns of undercut multi-layer, including bilayer, diffracting structures.

2. Background Art

Note that the following discussion refers to a number of publications by author(s) and year of publication, and that due to recent publication dates certain publications are not to be considered as prior art vis-à-vis the present invention. Discussion of such publications herein is given for more complete background and is not to be construed as an admission that such publications are prior art for patentability determination purposes.

Lithography is used to manufacture semiconductor devices, such as integrated circuits created on wafers, as well as flat-panel displays, disk read heads and the like. For example, lithography is used to transmit a pattern on a mask or reticle to a resist layer on a substrate through spatially modulated light. The resist layer is then developed and the exposed pattern is either etched away (positive resist) or remains (negative resist) to form a three dimensional image pattern in the resist layer. However, other forms of lithography are employed in addition to photoresist lithography.

In one form of lithography used in the semiconductor industry a wafer stepper is employed, which typically includes a reduction lens and illuminator, an excimer laser light source, a wafer stage, a reticle stage, wafer cassettes and an operator workstation. Modern stepper devices employ both positive and negative resist methods, and utilize either the original step-and-repeat format or a step-and-scan format, or both. In semiconductor wafer processing, the wafer substrate material undergoes a series of processing steps typically including doping, oxidation, deposition, lithography, etching and chemical mechanical polishing (CMP), among others. These steps result in formed patterns on the surface of the substrate. The formed patterns typically are semiconductor device components, and must be faithfully reproduced within close tolerances in order for the device to function. It is thus necessary to determine how faithfully the desired patterns are created on the surface of the wafer in order to have the end product device meet required specifications. Creation of the desired patterns within specifications is, in turn, largely a function of process parameters. Metrology tools are employed to measure the created patterns. The measured patterns are then compared to the desired patterns and process engineers, either directly or by means of a computer-based process control system, decide how to adjust the process steps in order to obtain patterns meeting the desired specifications.

Pattern surface measurements include critical dimensions (CD), profile characteristics and other parameters. Some semiconductor metrology instruments directly measure patterned surfaces while other instruments infer the patterned surfaces. Direct measurement tools use techniques which directly measure the patterning. Inference tools produce a measured signal related to the patterns and then infer the patterning.

Direct measurement tools are typified by scanning electron microscopes (SEM), atomic force microscopes, other electron microscopes, optical microscopes and similar devices. However, while SEM metrology can resolve features below 0.1 microns, the process is costly, requires a high vacuum chamber, is relatively slow in operation and is difficult to automate. Optical microscopes can be employed, but do not have the required resolving power for sub-micron structures.

One tool which infers the measurement is an optical scatterometer. Other inferential measurement tools include ellipsometers, reflectometers, and, in general, any spectroscopic diffraction-based technique employing any form of electromagnetic radiation. A variety of scatterometer and related devices and measurements can be used to characterize the microstructure of microelectronic and optoelectronic semiconductor materials, computer hard disks, optical disks, finely polished optical components, and other materials having lateral dimensions in the range of tens of microns to less than one-tenth micron. For example, the CDS200 Scatterometer, made and sold by Accent Optical Technologies, Inc. is a fully automated nondestructive critical dimension (CD) measurement and cross-section profile analysis system, partially disclosed in U.S. Pat. No. 5,703,692. This device can repeatably resolve critical dimensions of less than 100 nm while simultaneously determining the cross-sectional profile and performing a layer thickness assessment. This device monitors the intensity of a single diffraction order as a function of the angle of incidence of the illuminating light beam. The intensity variation of the 0^{th} or specular order as well as higher diffraction orders from the sample can be monitored in this manner, and this provides information that is useful for determining the properties of the sample target which is illuminated. Because the process used to fabricate the sample target determines the properties of a sample target, the information is also useful as an indirect monitor of the process. This methodology is described in the literature of semiconductor processing. A number of methods and devices for scatterometer analysis are taught, including those set forth in U.S. Pat. Nos. 4,710,642, 5,164,790, 5,241,369, 5,703,692, 5,867,276, 5,889,593, 5,912,741, 6,100,985, 6,137,570, and 6,433,878, each incorporated herein by reference.

Scatterometers and related devices can employ a variety of different methods of operation. In one method, a single, known wave-length source is used, and the incident angle Θ is varied over a determined continuous range. In another method, a number of laser beam sources are employed, optionally each at a different incident angle Θ. In yet another method, an incident broad spectral light source is used, with the incident light illuminated from some range of wavelengths and the incident angle Θ optionally held constant. Variable phase light components are also known, utilizing optics and filters to produce a range of incident phases, with a detector for detecting the resulting diffracted phase. It is also possible to employ variable polarization state light components, utilizing optics and filters to vary the light polarization from the S to P components. It is also possible to adjust the incident angle over a range φ, such that the light or other radiation source rotates about the target area, or alternatively the target is rotated relative to the light or other radiation source. Utilizing any of these various devices, and combinations or permutations thereof, it is possible and known to obtain a diffraction signature for a periodic structure.

Besides scatterometer devices, there are other devices and methods capable of determining the diffraction signatures at the 0^{th} order or higher diffraction orders using a light-based source that can be reflected off of or transmitted through a periodic structure, with the light captured by a detector. These other devices include ellipsometers and reflectometers. It is further known that non-light-based diffraction signatures may be obtained, using other radiation sources such as, for example, X-rays.

Diffraction gratings or other target periodic structures are typically dispersed in a known pattern within dies on a wafer. CD may be determined using scatterometry by comparing diffraction signatures from a diffraction grating to a theoretical model library of diffraction grating signatures yielding information regarding CD. The actual diffraction measures are compared to the model, from which CD values are derived. Because the optical response of a diffraction grating or other periodic structure can be rigorously simulated from Maxwell's equations, the most common methods are model-based analyses. These techniques rely on comparing the measured scatter signature to signatures generated from a theoretical model. Both differential and integral models have been explored. Because these diffraction models are computationally intensive, standard regression techniques generally cannot currently be utilized without introducing errors due to the performance of the regression, but if the errors are small or tolerable, a regression approach can be used. Generally, however, the model is used a priori to generate a series of signatures that correspond to discrete iterations of various grating parameters, such as its thickness and the width of the grating lines. The set of signatures that results when all parameters are iterated over some range of values is known as a signature library. When the scatter signature is measured, it is compared against the library to find the closest match. Standard Euclidean distance measures, such as minimizing the mean square error (MSE) or root mean square error (RMSE), are used for identifying the closest match. The parameters of the modeled signature that agrees most closely with the measured signature are taken to be the parameters of this measured signature.

U.S. Patent Application Publication No. 2002/0035455, to Niu and Jakatdar, is typical of a model based system employed to generate a library of simulated diffraction signals of a periodic structure. In the general method, a library is generated based on an assumed theoretical profile of a periodic structure, optionally taking into account parameters such as characterization of the film stack of the periodic structure, the optical properties of materials used in forming the periodic structure, assumed ranges of hypothetical parameters, resolution used to generate the library constituent members, and the like. However, the method of U.S. Patent Application Publication No. 2002/0035455, typical of the prior art, begins the process by assuming the shape and other parameters of the periodic structure. Other similar disclosures include U.S. Patent Application Publication Nos. 2002/0112966, 2002/0131040, 2002/0131055 and 2002/0165636.

Inference tools typically cannot measure an unknown pattern, which is to say determine relevant CD or other parameters, other than by comparison of the diffraction signal of the unknown pattern to a measured diffraction signal of a known pattern or to a diffraction signal mathematically derived from a hypothetical pattern. It is known to design a set of model patterns and the corresponding diffraction signals which either include the expected pattern or include a model pattern within the instrument's accuracy and precision of any expected patterns. Analysis of the measured signal, guided by comparison to patterns from a close match diffraction signal, results in an inference of the actual patterning.

A major problem in the analysis is determining relevant patterns. A graphical user interface (GUI) or similar method can be employed with which the user draws a pattern. For example, a GUI can supply the user with a set of predefined shapes which may be incorporated into the desired pattern. The user may also specify the material of which each shape is made. In this manner, a complex model pattern may be built up. On submission, the model pattern must be checked for physical reasonableness. If a set of model patterns is desired, then the user must specify how the shapes may change. For example, a rectangle is specified by width and height. To create a model pattern set, the user can enter a range of widths and heights as well as the stepping within the ranges.

Once a model pattern or model pattern set is determined, a library of model diffraction signals may be derived therefrom. A model signal library is constructed based on simulation of the model patterns utilizing Maxwell's equations. The simulation may be complex, and include factors such as CD, relevant pitches, focus, exposure, resist type, resist thickness, temperature, numerical aperture, substrate composition, material composition and the like.

If a single model pattern is submitted, then the analysis employed usually incorporates some type of error minimization algorithm. The error is the difference between the measured signal and a model signal. The model signal is derived from the model pattern such that if the model pattern and measured pattern are the same, then the model signal and measured signal are the same. Minimizing the error is usually an iterative process in which the analysis algorithm calculates the error and then uses the error, as well as previous error calculations, to generate a new model pattern. In order to generate a new model pattern, the analysis must choose a shape to change and how to change it.

It is known to make structures with multiple layers (multi-layer structures), such as for example bilayer structures. For example, U.S. Pat. No. 6,531,383 discloses a semiconductor device consisting of a substrate on which is deposited a GaN buffer layer, with an n-type semiconductor layer formed on the GaN buffer layer, and an electrode structure formed on the n-type semiconductor layer. The electrode structure includes a titanium layer, an aluminum layer formed on the titanium layer, a platinum layer formed on the titanium layer, and a gold layer formed on the platinum layer. The electrode structure thus includes four distinct and different layers. U.S. Pat. No. 6,509,137 discloses a method of “almost same” pattern thin photoresist layers accumulated to form a composite photoresist layer with a desired thickness. Thus a structure may have two or more layers. It is also known to use a bilayer process in which the top layer and the bottom layer are made of different material, and are coated on a wafer in sequence. The top photoresist layer is patterned, and subsequently the bottom layer is dry-etched. The top patterned photoresist layer is in combination with the bottom layer to form a thick composite photoresist layer. In yet another example, bilayer structures are deposited on hard drive media, such as read heads. For example, bilayer structures are created during the manufacturing of magneto-resistive (MR) and giant magneto-resistive (GMR) heads for hard disk drives. In a particular step of the process, a lift-off resist (LOR) is typically deposited on a multi-layer thin film stack on top of a substrate such as NiFe. After the LOR is prebaked, the structure is coated with imaging resist with the resist being subsequently prebaked. The imaging and lift-off resist is exposed. During the development process, the imaging resist is developed, and depending on the lift-off resist's properties it may also be developed or else etched in a separate processing step. The resulting structure has the imaging resist layer with a larger CD than the lift-off resist layer.

It is known that the etch step, in which material is removed from a surface via chemical reactions and/or ion bombardment, produces different results with different materials. That is, different materials on the wafer surface will experience different etch rates and/or different etch profiles, resulting in an undercut. Additionally, parameters such as temperature, material, gas flow rate, gas composition, output power of power supply, power supply modulation, level of vacuum in the processing chamber, reaction products from the etch process, processing duration and the like will also affect the etch process. Thus in multi-layer or bilayer structures the rate of removal of materials, and the results of subsequent strip steps, will vary for different materials in the different layers. Thus even assuming precise overlay the resulting structure may nonetheless have a non-uniform width, such as first layer material having width a and second layer material having width b, where b is greater than a. Typically, the top-most layer or layers will have a width greater than lower layers, but any conceivable geometric configuration is possible.

Prior art models used to generate diffraction signatures have employed simple structures, such as those shown in FIGS. 1, 2 and 3. FIG. 1 depicts the simplest model, rectangular structure 10, 10′, 10″ positioned on substrate 16. Somewhat more complex models are employed, such as trapezoidal overcut structure 12, 12′, 12″ positioned on substrate 16 or trapezoidal undercut structure 14, 14′, 14″ positioned on substrate 16. While some prior art models have considered the film thickness and index of refraction of films underneath the structure, as disclosed in U.S. Pat. No. 6,483,580, these models have nonetheless only employed conventional single layer rectangular or trapezoidal structures.

There is thus a need for models of the periodic structure of bilayer or multi-layer structures which represent the range of possible structures actually obtainable, and which may be employed to more accurately model such structures.

### SUMMARY OF THE INVENTION (DISCLOSURE OF THE INVENTION)

In one embodiment, the invention provides a method of making a library of simulated diffraction signals of an undercut multi-layer diffracting structure fabricated on a semiconductor substrate for use in semiconductor metrology. In the method the following steps are employed:

specifying at least one first layer model structure with at least one second layer model structure positioned thereon and extending beyond the first layer model structure in at least one dimension to define a first undercut model pattern of a diffracting structure;

specifying at least one second undercut model pattern of a diffracting structure by varying at least one parameter associated with the first layer model structure or the second layer model structure;

generating simulated diffraction signatures from members of the undercut model patterns of the multi-layer diffracting structure;

obtaining a diffraction signature of the diffracting structure on a semiconductor substrate; and

comparing the diffraction signature of the diffracting structure to the simulated diffraction signatures of members of the undercut multi-layer model patterns of the diffracting structure.

In this method, the parameters associated with a model pattern producing a close match simulated diffraction signature can be modified to determine a better or best match model pattern.

In the performance of the method, a diffraction signature of the diffracting structure on a semiconductor substrate can include use of a radiation source-based tool, such as a light source-based tool. The light source-based tool can include an incident laser beam source, an optical system focusing the laser beam and scanning through some range of incident angles, and a detector for detecting the resulting diffraction signature over the resulting measurement angles. Thus in one embodiment the light source-based tool is an angle-resolved scatterometer. In another embodiment, the light source-based tool includes a plurality of laser beam sources. The light source-based tool can further include an incident broad spectral light source, an optical system focusing the light and illuminating through some range of incident wavelengths, and a detector for detecting the resulting diffraction signature over the resulting measurement wavelengths. In this method, the light source-based tool can also include an incident light source, components for varying the amplitude and phase of the S and P polarizations, an optical system focusing the light and illuminating over some range of incident phases, and a detector for detecting the phase of the resulting diffraction signature.

The step of obtaining a diffraction signature of the diffracting structure on a semiconductor substrate can include phase measurement by means of a broad spectral radiation source-based tool source, operating at a fixed angle, a variable angle Θ or a variable angle φ. Alternatively, it can phase measurement by means of a single wavelength radiation source-based tool source, operating at a fixed angle, a variable angle Θ or a variable angle φ. It can also include phase measurement by means of a multiple discrete wavelength radiation source-based tool source, or in yet another alternative can obtaining a reflective diffraction signature or obtaining a transmissive diffraction signature. The diffraction signature of the diffracting structure can be a specular order diffraction signature or a higher order diffraction signature.

The step of generating simulated diffraction signatures of members of multi-layer model patterns of the diffracting structure can include submission to a remote computer on a computer network, optionally wherein results are retrieved from or returned by the remote computer.

In another embodiment, a method of determining at least one parameter associated with an undercut multi-layer diffracting structure fabricated on a semiconductor substrate is provided, which method includes the following steps:

specifying at least one first layer model structure with at least one second layer model structure positioned thereon and extending beyond the first layer model structure in at least one dimension to define an undercut model pattern of a diffracting structure;

generating a simulated diffraction signature from the undercut model pattern of the multi-layer diffracting structure;

obtaining a diffraction signature of the diffracting structure on a semiconductor substrate;

comparing the diffraction signature of the diffracting structure to the simulated diffraction signature of the undercut multi-layer model pattern of the diffracting structure;

utilizing regression analysis to vary at least one parameter associated with the first layer model structure or the second layer model structure of the undercut multilayer model pattern to obtain a best match model pattern.

A primary object of the present invention is to provide libraries of diffraction signatures or other inferred electromagnetic measuring parameters relating to an undercut multi-layer diffracting structure utilizing an undercut multi-layer pattern or patterns, optimally based on the fabrication parameters of the multi-layer diffraction structure.

Another object of the present invention is to provide a method for construction of a library of diffraction signatures or other inferred electromagnetic measuring parameters utilizing a graphic user interface to create one or more undercut multi-layer structure patterns.

Another object of the present invention is to provide a method for determining or measuring parameters relating to an undercut diffracting structure utilizing a library modeled on multi-layer diffracting structures.

Another object of the present invention is to provide a method for determining or measuring parameters relating to an undercut diffracting structure utilizing real-time regression analysis on the modeled undercut multi-layer diffracting structures.

Another object of the present invention is to provide a method for determining or measuring parameters associated with a lithography device by obtaining a diffraction signature utilizing any method to create a diffraction signature, including but not limited to reflective or transmissive angle-resolved, variable wavelength, variable phase, variable polarization state or variable orientation diffraction, or a combination thereof, of the 0^{th} or specular diffraction order or any higher orders, and comparison of the results thereby obtained to a library modeled on undercut multi-layer diffracting structures.

Another object of the present invention is to provide a method for determining or measuring parameters associated with a lithography device by obtaining a diffraction signature utilizing any method to create a diffraction signature, including but not limited to reflective or transmissive angle-resolved, variable wavelength, variable phase, variable polarization state or variable orientation diffraction, or a combination thereof, of the 0^{th} or specular diffraction order or any higher orders, and thereafter utilizing real-time regression analysis based on modeled undercut multi-layer diffracting structures.

Another object of the present invention is to provide a method and device for determining or measuring parameters associated with a lithography device as a function of focus, dose or other process parameters by means of a library modeled on undercut multi-layer diffracting structures.

Another object of the present invention is to provide a method for determining or measuring parameters associated with a lithography device, including undercut multi-layer structures, by means of any order of diffraction signature of diffracting structures, including the 0^{th} or specular order or any higher order diffraction, either positive or negative.

A primary advantage of the present invention is that it permits measuring parameters relating to undercut multi-layer structures without the use of optical, SEM or similar microscopy metrology tools.

Another advantage of the present invention is that it provides a method that permits generating a library of structures and the corresponding library of resulting diffraction signatures based on an undercut multi-layer diffracting structure modeled on the structure actually made.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a prior art model rectangular structure 10, 10′, 10″ positioned on substrate 16;

FIG. 2 is a prior art model trapezoidal overcut structure 12, 12′, 12″ positioned on substrate 16;

FIG. 3 is a prior art model trapezoidal undercut structure 14, 14′, 14″ positioned on substrate 16′

FIG. 4 is a graphic representation of an undercut bilayer model rectangular structure positioned on a two-layer substrate;

FIG. 5 is a graphic representation of an undercut bilayer model trapezoidal and rectangular structure positioned on a substrate;

FIG. 6 is a graphic representation of an undercut bilayer model structure with a trapezoid top layer with additional profile features on a rectangular second layer positioned on a three-layer substrate;

FIG. 7 is a graphic representation of an undercut bilayer model structure with a trapezoid top layer with additional profile features and additional interfacing modeling on a rectangular second layer positioned on a three-layer substrate;

FIG. 8 is a graphic representation of an undercut bilayer model structure with a trapezoid top layer with additional profile features on a rectangular second layer with additional interface modeling positioned on a three-layer substrate;

FIG. 9 is a graphic representation of an undercut bilayer model structure with a trapezoid top layer with additional profile features and additional interfacing modeling on a complex-shaped second layer positioned on a two-layer substrate; and

FIG. 10 is a sample diffraction signature response from changes in CD of the bottom layer in an undercut bilayer structure, where the figure plotted is angular response, S polarization, at 0° to 47° incident angle.

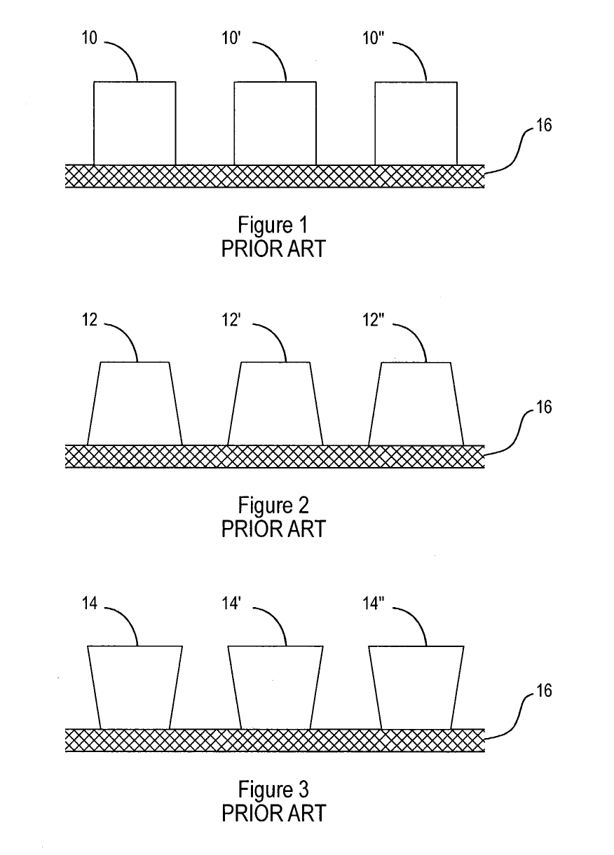

### DESCRIPTION OF THE PREFERRED EMBODIMENTS (BEST MODES FOR CARRYING OUT THE INVENTION)

As described in this application, methods and devices are provided whereby scatterometry, and by extension other radiation source-based tools as described herein, can be employed to determine and quantify critical dimensions of the lower-most layers in undercut multi-layer devices. This has particular application for measuring parameters relating to undercut bilayer devices. The invention further provides for model undercut structures based on the actual structure presumptively made, such as an undercut multi-layer model structure for an undercut multi-layer device or an undercut bilayer model structure for an undercut bilayer device.

The invention is of particular use in bilayer devices, that is, devices in which there are two discrete layers, such that a given structure has two such components. However, the invention is also applicable to devices that include two or more layers, such as multi-layer devices, it being understood that a bilayer is a type of multi-layer.

In the practice of the invention, a measured diffraction signature is obtained. The measured diffraction signature is compared to a simulated or theoretically generated diffraction signature based upon a simulation or simulations of the model structure or stack as provided herein. From this, the structure or stack's profile can be determined.

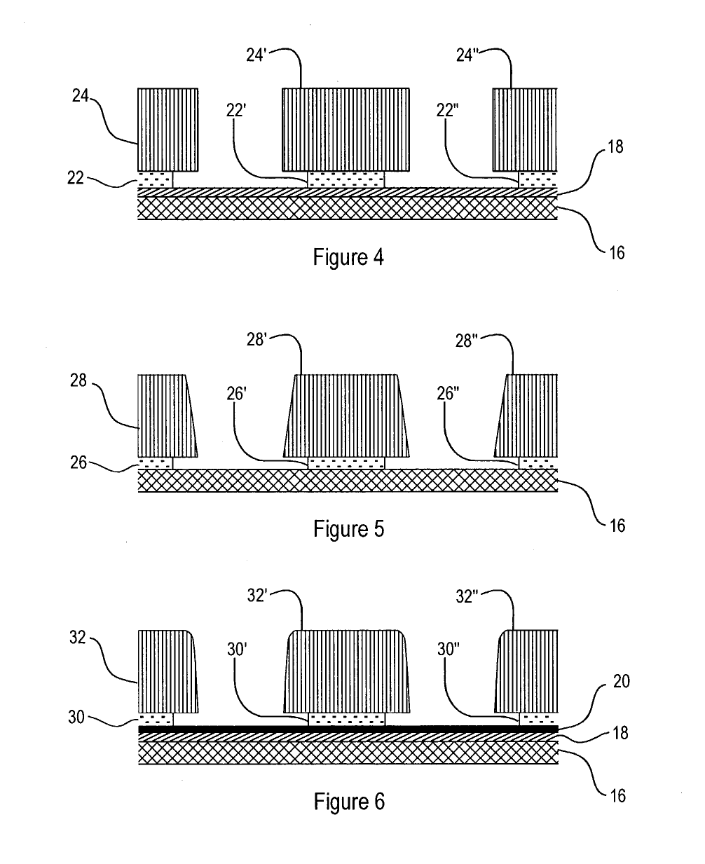

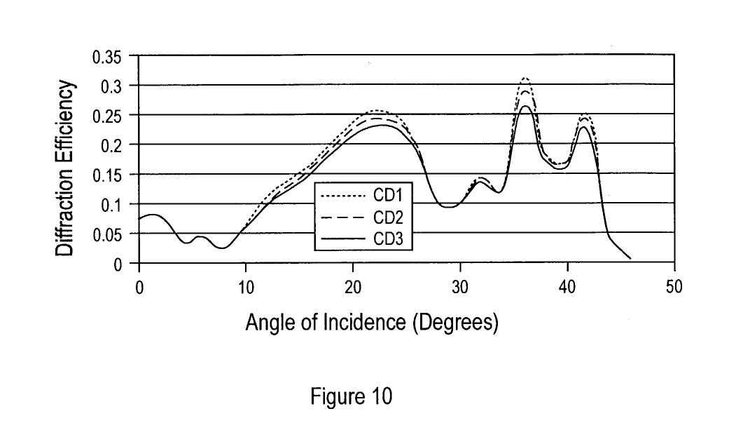

The bilayer undercut stack or structure, with or without underlying thin films, can be manufactured in a periodic array forming a diffraction grating and suitable for obtaining diffraction signatures. Each structure can be designed to mimic the final process stack. The radiation passes through the stack and underlying thin films and is either reflected back, transmitted through, or a combination of the two. Because of the radiation's ability to transmit through the top layer and into the second layer, the critical dimensions, width and general profile of each layer can be characterized. This is particularly critical to the disk storage industry, where control of the undercut process during disk head manufacturing is critical. FIGS. 4 to 9 below present several potential models used to characterize the undercut stack. FIG. 10 presents different sample diffraction signatures where the lower CD of the bottom grating layer is varied.

Before proceeding to further describe the invention, the following definitions are given.

A lithography device refers to any device that utilizes an image, such as a mask, to transfer a pattern to and optionally into a substrate. This thus includes conventional optical lithography, such as photoresist lithography, but also includes other methods of lithography. In photoresist lithography, also called photolithography, optical methods are used to transfer circuit patterns from master images, called masks or reticles, to wafers. In this process, one or more specialized materials called resists are coated on the wafers on which the circuits are to be made. A resist coat is applied as required, and as required the wafer is further processed, such as by a softbake. Either positive or negative photoresist materials may be employed. Positive resists are normally insoluble in chemicals used as resist developers, but become soluble by exposure to light. Negative resists are normally soluble in chemicals used as resist developers, but become insoluble by exposure to light. By exposing the resist selectively in some areas but not others, the pattern of the circuit or other structure is created in the resist film. In optical lithography, the selective exposure is accomplished by imaging of a mask, typically by shining light onto the mask and projecting the transmitted image onto the resist film.

The lithography devices referenced in this invention include steppers, also known as wafer steppers, which are used to project the image of a circuit or other structure from a photomask onto a resist-coated wafer. A stepper typically includes reduction lens and illuminator, excimer laser light source, wafer stage, reticle stage, wafer cassettes and an operator workstation. Steppers employ both positive and negative resist methods, and utilize either a step-and-repeat format or a step-and-scan format, or combination thereof.

There is employed in one method of this invention a wafer or other substrate on which is fabricated a series of multi-layer periodic structures by means of a lithographic device. One form of multi-layer periodic structure is a diffraction grating, including any structure or image made by lithographic means which generates a periodic variation of the refractive index relative to an incident illumination. This change in refractive index can be either due to a physical difference or a chemical difference. Physical differences include photoresist or other lithographically generated changes, such as utilizing a material with one refractive index coupled with air, such as ordinary scored optical diffraction gratings, or a material coupled with a different material. Chemical differences include wafers with photoresist exposed diffraction gratings, where the resist has not yet been developed. In this case all of the resist is still present, but the portions that have been exposed have a different refractive index than the non-exposed resist portions, thereby creating a diffraction grating consisting of periodic variations of refractive index in the resist. The periodic difference is obtained by the periodicity of structural or chemical elements. This thus includes conventional diffraction gratings consisting of a series of parallel lines, but also includes gratings such as a three-dimensional array of posts or holes, wherein there is periodicity in both in the X direction and Y direction. Diffraction gratings thus include photoresist gratings, etched film stack gratings, metal gratings and other gratings known in the art. The width and pitch of the periodic structure can be any feasible size, depending in large part on the resolution of the lithographic device.

In the practice of this invention, a periodic structure is used to generate a diffraction signature. A diffraction signature can be generated by any of a number of instruments, such as scatterometers, ellipsometers or reflectometers. Any device employing radiation to generate a diffraction signature is referred to herein as a radiation source-based tool. Typically a visible radiation source-based tool, such as a light source-based tool, is employed, but the radiation source may be other than visible radiation, and thus may be any form of electromagnetic radiation, including radiation such as that obtained with an X-ray source. In one embodiment, the diffraction signature is created by a reflective mode, wherein the radiation, such as light, is reflected. Thus a diffraction signature may be generated by means of an angle-resolved scatterometer, wherein a single known wave-length source is used, and the incident angle e is varied over a determined continuous range. The resulting diffraction signature can have the intensity of light plotted against the incident and reflective angle Θ. In another method, a number of laser beam sources are employed, optionally each at a different incident angle Θ. In yet another method, an incident broad spectral light source is used, with the incident light illuminated from some range of wavelengths and the incident angle Θ optionally held constant. Variable phase light sources are also known, utilizing a range of incident phases, with a detector for detecting the resulting diffracted phase. Variable polarization light sources are also known, utilizing a range of polarization from the S to P components or the P to S components. It is also possible to adjust the incident angle over a range φ, such that the light source rotates about the diffraction grating, or alternatively the diffraction grating is rotated relative to the light source. Utilizing any of these various devices, and combinations or permutations thereof, it is possible and known to obtain a diffraction signature for a sample target. In general, the detected light intensity is plotted against the at least one variable parameter, such as angle of incidence Θ, wavelength of incident light, phase of incident light, angle of sweep φ or the like. The diffraction signature may represent the 0^{th} or specular diffraction order, or may represent any higher diffraction order. It is also possible and contemplated that a transmissive mode may be employed to generate a diffraction signature, such as by use of an X-ray radiation source as a component of the radiation source-based tool.

In one embodiment of the invention, a wafer is provided on which is disposed a series of dies. Each die typically represents that portion of the wafer representing the exposure field of the lithographic device, such as a stepper. In a step-and-repeat system, the entire area of the mask or reticle to be exposed is illuminated when the shutter is opened, thereby simultaneously exposing the entire die exposure field. In a step-and-scan system, only a part of the reticle or mask, and thus only a part of the die exposure field, is exposed when the shutter is opened. In either event, the reticle or mask may be moved such that a diffraction grating set is produced, the diffraction grating set being composed of a series of different, optionally different focus, diffraction gratings, wherein the gratings are multi-layer, such as a bilayer structure. It is also possible that the diffraction grating set is composed of a series of the same diffraction gratings, or is composed of a series of diffraction gratings varying by one or more process parameters, such as focus, dose or the like. It is also possible that from die to die on a wafer, one or more process parameters, such as dose range or focus setting range or both, may vary. Conventionally, the dose or focus is varied in constant incremental steps, thereby facilitating subsequent analysis. Thus the focus, for example, might vary in 50 to 100 nm steps over a determined range, and the dose, for example, might vary in 1 or 2 mJ increments over a determined range.

The diffraction gratings are typically created in a resist material by preparing masks with opaque and transparent areas corresponding to the desired shape, size and configuration of the desired diffraction grating. A source of radiation is then applied on one side of the mask, thereby projecting the mask shape and spaces onto the resist layer, the resist layer being on the opposite side of the mask. One or more lens or other optical systems may be interposed between the mask and the resist layer, and also optionally between the radiation source and the mask. When exposed to radiation or energized at sufficient levels to effect a change in the resist, a latent image is formed in the resist. The latent images, representing a chemical change in the resist material, result in changes in reflectivity of the resist layer, and thus may be employed to generate a diffraction signature as set forth above. A second resist layer may then be applied, and the exposure step repeated. In one embodiment, the wafer with latent images in the resist may be subjected to a post-exposure bake, used to drive additional chemical reactions or to diffuse components within the resist layer. In yet another embodiment, the resist may be developed by a development process, optionally a chemical development process, whereby a portion of the resist is removed, such portion determined by whether a positive resist or negative resist was employed. The development process is also referred to as an etching process, resulting in etched areas or spaces of the resist layer, and optionally the substrate material, such as other films, on which such resist layer is placed.

In the methods and devices of this invention, the actual diffraction grating may be exposed but not developed, or may alternatively be developed. Similarly, while the foregoing generally describes a conventional method of generating a diffraction grating or other periodic structure, any process method step may be employed, including use of phase shift masks, any of a variety of sources of radiation, including electron beam exposure, and the like. It may readily be seen that for any process method step it is only necessary to model such step, as described herein.

In one embodiment of the invention, a theoretical library of undercut multi-layer diffraction structures and corresponding simulated or theoretical diffraction signals, such as diffraction signatures, is generated, with theoretical diffraction signatures based on the theoretical undercut multi-layer diffraction structures compared to the measured diffraction signature. This may be done by any number of different methods. In one approach, an actual library of theoretical output signals are generated, based on assigned parameters for variables. This library may be generated prior to actual measurement of a diffraction signature or may be generated in a process of matching the measured diffraction signature to a theoretical diffraction signature. Thus as used herein a theoretical library includes both a library generated independent of the measured diffraction signature and a library generated based on a theoretical “best guess” of the geometry of the measured undercut multi-layer structure and calculation of the resulting theoretical diffraction signature, with iterative comparison to changed parameter structures to determine a best match. The library may optionally be pruned by removing signals that may be accurately represented via interpolation from other signals in the reference set. An index of the library can similarly be generated by correlating each signature with one or more indexing functions and then ordering the index based on the magnitude of the correlation. Construction or generation of libraries of this type, and methods for optimization thereof, are well known in the art. In one approach, a rigorous, theoretical model based on Maxwell's equations is employed to calculate a predicted optical signal characteristic of the diffraction structure, such as the diffraction signature, as a function of diffraction structure parameters. In this process, a set of trial values of the diffraction structure parameters is selected. Then, based on these values a computer-representable model of the diffraction structure, including its optical materials and geometry, is constructed. The electromagnetic interaction between the diffraction structure and illuminating radiation is numerically simulated to calculate a predicted diffraction signature. Any of a variety of fitting optimization algorithms may be employed to adjust the diffraction structure parameter values, with the process iteratively repeated to minimize discrepancy between the measured and predicted diffraction signature, thereby obtaining the best match. U.S. Published Patent Application No. US 2002/0046008 discloses one database method for structure identification, while U.S. Published Patent Application No. US 2002/0038196 discloses another method. Similarly, U.S. Published Patent Application No. US 2002/0135783 discloses a variety of theoretical library approaches, as does U.S. Published Patent Application No. US 2002/0038196.

Generation of libraries from a model pattern is well known in the art, as disclosed in a number of references, such as U.S. Patent Application Publication Nos. 2002/0035455, 2002/0112966, 2002/0131040, 2002/0131055 and 2002/0165636, among others. Early references to these methods include R. H. Krukar, S. S. H. Naqvi, J. R. McNeil, J. E. Franke, T. M. Niemczyk, and D. R. Hush, “Novel Diffraction Techniques for Metrology of Etched Silicon Gratings,” OSA Annual Meeting Technical Digest, 1992 (Optical Society of America, Washington, D.C, 1992), Vol 23, p. 204; and R. H. Krukar, S. M. Gaspar, and J. R. McNeil, “Wafer Examination and Critical Dimension Estimation Using Scattered Light,” Machine Vision Applications in Character Recognition and Industrial Inspection, Donald P. D'Amato, Wolf-Ekkehard Blanz, Byron E. Dom, Sargur N. Srihari, Editors, Proc SPIE, 1661, pp 323-332 (1992).

Other approaches to matching, including real-time regression analysis, may similarly be employed. These methods are known in the art, and may be employed to determine a “best fit” theoretical diffraction signal, such as a diffraction signature, based on model permutation, such as permutation in an undercut multi-layer diffracting structure. In the technique generally described as iterative regression, one or more simulated diffraction signatures are compared to a measured diffraction signature, thereby creating a difference of error signal, with another simulated diffraction signature then calculated and compared to the measured diffraction signature. This process is repeated or iterated until the error is reduced, which is to say regressed, to a specified value. One method of iterative regression is non-linear regression, which may optionally be performed in a “real-time” or “on the-fly” mode. Different iterative regression algorithms, familiar to those skilled in the art, may be applied to interpretation of measured diffraction signatures through comparison with simulated diffraction signatures based on model structure profiles.

In addition to the parameters associated with undercut multi-layer patterns, other diffraction structure parameters that may be utilized in a theoretical library include any parameter that may be modeled, including factors such as the period of a grating; materials parameters of the structure, including parameters of various layers thereof; materials parameters of the substrate on which a structure is placed, such as film thickness and index of refraction of films underneath the structure; and various weighted or average values, such as CD at a specified location, values weighted by relative contributions of the structure and substrates, or the like.

FIG. 4 presents a simple case model structure for use in this invention. In FIG. 4, substrate 16 is, for example, a wafer substrate, on which is deposited thin film 18, such as Al₂O₃. The bilayer structure depicted is composed of two layers, first layer 22, 22′, 22″, such as PMGI-based lift-off resist, on which is positioned second layer 24, 24′, 24″, such as an imaging resist. In this instance, both first layer 22, 22′, 22 and second layer 24, 24′, 24″ are rectangular in cross-section, with the width (CD) of second layer 24, 24′, 24″ being significantly greater than the width of first layer 22, 22′, 22. For modeling purposes, a library can be composed, such that the ratio of width of first layer 22, 22′, 22 to that of second layer 24, 24′, 24″ varies over a range determined to be possible, in such as increments as are desired to provide the necessary match capabilities based upon simulated or theoretical diffraction signals, such as diffraction signatures, derived from such model structure. Similarly the height of each of both first layer 22, 22′, 22 and second layer 24, 24′, 24″ can be varied over a range determined to be possible, and the ratio of first layer 22, 22′, 22 to that of second layer 24, 24′, 24″ similarly varied, again in such increments as appropriate.

FIG. 5 presents trapezoid second layer 28, 28′, 28″ positioned on rectangular first layer 26, 26′, 26″ positioned on substrate 16. Here too the width and height, both absolute and by way of ratio, of each of first layer 26, 26′, 26″ and second layer 28, 28′, 28″ can be varied. However, the internal angles forming the trapezoidal shape of second layer 28, 28′, 28″ can also be varied, such that the shape of the trapezoid is varied over a range determined to be possible.

FIG. 6 presents presents trapezoid second layer 32, 32′, 32″ with an additional profile feature, including rounded top corners, positioned on rectangular first layer 30, 30′, 30″, in turn positioned on thin film 20, which is positioned on thin film 18, which is in turn positioned on substrate 16. As in the case of FIG. 5, the width and height, both absolute and by way of ratio, of each of first layer 30, 30′, 30″ and second layer 32, 32′, 32″ can be varied, as can the internal angles forming the trapezoidal shape of second layer 32, 32′, 32″. However, the rounded top corners of second layer 32, 32′, 32″ can further also be varied, such that the corners can be rounded as the arc of a circle, the arc of an ellipse or another geometric shape, and similarly the radius of the circle, ellipse or other geometric shape can be varied, such that the curvature varies, again over a range determined to be possible and relevant to the generation of simulated or theoretical diffraction signals, such as diffraction signatures, derived from such model structure.

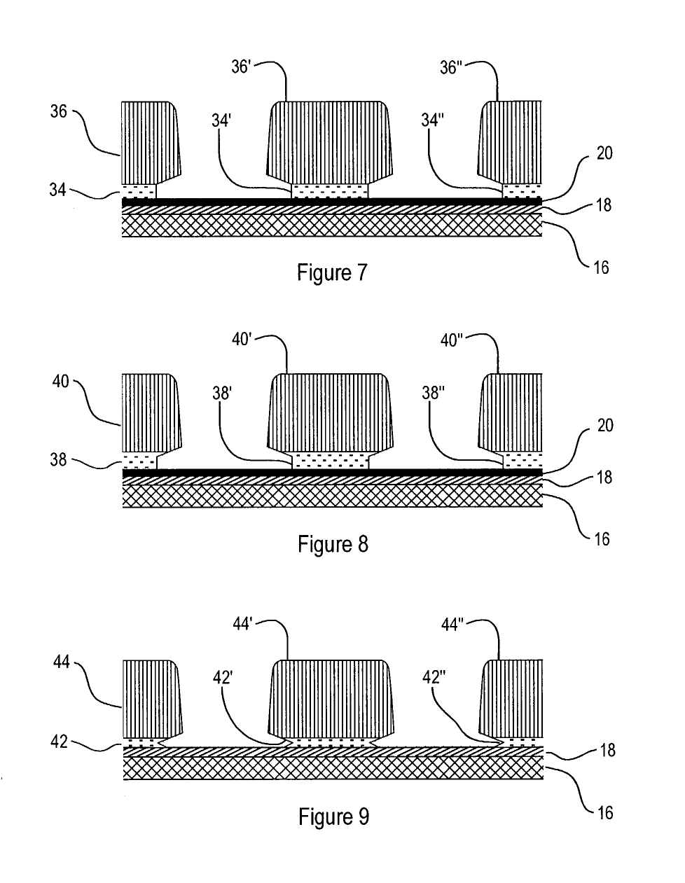

FIG. 7 describes a model structure as in FIG. 6, with additional interface modeling between first layer 34, 34′, 34″ and second layer 36, 36′, 36″. FIG. 8 describes another model structure again as in FIG. 6, with additional interface modeling between first layer 38, 38′, 38″ and second layer 40, 40′, 40″. In each instance all of the parameters discussed above can be varied, and the additional interface modeling can be varied over similar parameters. FIG. 9 discloses a model structure as in FIG. 6, but omitting thin film 20, again with additional interface modeling between first layer 42, 42′, 42″ and second layer 44, 44′, 44″, resulting in a complex shape of first layer 42, 42′, 42″.

FIG. 10 depicts simulated diffraction signature responses from the change in underlying CD of a bilayer model structure, as in any of FIG. 4 to FIG. 9, showing how comparatively small changes in a specifically-relevant model results in a difference in simulated diffraction signal responses, here simulated or theoretical diffraction signature responses, such that more precise and accurate matches can be generated. In FIG. 10, CD1, CD2 and CD3 differ only in that a critical dimension of the first layer (such as for example first layer 22, 22′, 22″ of FIG. 4) is varied, such as for example the amount of undercut is varied. Thus different amounts of undercut, for example, can be readily modeled, without the need to employ destructive metrology techniques heretofore utilized, such as cross-section SEM or focused ion beam. Small changes in CD of the undercut first layer thus result in significant differences in the diffraction signal, such as the diffraction signature, and thus may be employed in metrology of multi-layer structures.

In FIG. 10, the diffraction signatures are plotted as an angular response, S polarization, at a 0° to 47° incident angle. However, similar results can be obtained from other relevant methods of determining a simulated or theoretical diffraction signal or signature, including use of any form of spectral radiation source-based tool source, operating at a fixed angle, a variable angle Θ or a variable angle φ, a reflective diffraction signature, a transmissive diffraction signature, a specular order diffraction signature or a higher order diffraction signature.

The methods of this invention may be employed with any undercut multi-layer diffracting structure, including any undercut bilayer diffracting structure. In one embodiment, the method is employed for metrology of hard disk read heads. Such heads typically employ at least a bilayer structure deposited on a substrate layer, the substrate typically being metal, with resist of the top layer and bottom layer of the bilayer differentially removed, such that the top layer has a larger CD in at least one dimension than the CD of the bottom layer, thereby defining an undercut. Typically the resulting structure is employed as a mask for subsequent metal deposition, with the remaining resist removed after metal deposition, leaving a metal structure with a “stair-step” configuration. The methods described herein can be employed for metrology of the developed resist structures. Thus the method may be employed with any applicable type of read head geometry, including without limitation various MR technologies, such as GMR or tunneling MR, as well as alternative technologies, such as those employed for nonmagnetic semiconductor-metal composite read heads.

In another embodiment, the methods disclosed herein may be used in metrology of photomasks. For examples, certain masks employ a metal, such as chrome, deposited on a substrate, such as glass or quartz, and with the substrate subsequently partially etched away, resulting in an undercut bilayer structure. In a related embodiment, various phase shift masks and reticles employ undercut structures, with the portions overlaying the undercut frequently exhibit the damping or frequency doubling associated with the phase shift. Thus the methods disclosed herein may be used for quality control testing of a mask or reticle, provided only that such devices employs an undercut bilayer or multi-layer structure.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A method of specifying an undercut multi-layer model pattern of a diffracting structure for use in semiconductor metrology, the diffracting structure to be fabricated on a semiconductor substrate employing a lithographic process, the method comprising:
specifying a first layer model structure; and
specifying at least one second layer model structure positioned on and extending beyond the first layer model structure in at least one dimension to produce an undercut model pattern of the diffracting structure.

2. A method of making a simulated diffraction signal of an undercut multi-layer diffracting structure fabricated on a semiconductor substrate, the method comprising:
specifying a first layer model structure;
specifying at least one second layer model structure positioned on and extending beyond the first layer model structure in at least one dimension to define an undercut model pattern; and
generating a simulated diffraction signal from the undercut model pattern of the diffracting structure.

3. A method of making a library of simulated diffraction signals of an undercut multi-layer diffracting structure fabricated on a semiconductor substrate for use in semiconductor metrology, the method comprising:
specifying at least one first layer model structure with at least one second layer model structure positioned on the first layer model structure and extending beyond the first layer model structure in at least one dimension to define a first undercut model pattern of a diffracting structure;
specifying at least one second undercut model pattern of a diffracting structure by varying at least one parameter associated with the first layer model structure or the second layer model structure; and
generating simulated diffraction signals from members of the undercut model patterns of the multi-layer diffracting structure.

4. A method of making a library of simulated diffraction signals of an undercut multi-layer diffracting structure fabricated on a semiconductor substrate for use in semiconductor metrology, the method comprising:
specifying at least one first layer model structure with at least one second layer model structure positioned thereon and extending beyond the first layer model structure in at least one dimension to define a first undercut model pattern of a diffracting structure;
specifying at least one second undercut model pattern of a diffracting structure by varying at least one parameter associated with the first layer model structure or the second layer model structure;
generating simulated diffraction signatures from members of the undercut model patterns of the multi-layer diffracting structure;
obtaining a diffraction signature of the diffracting structure on a semiconductor substrate; and
comparing the diffraction signature of the diffracting structure to the simulated diffraction signatures of members of the undercut multi-layer model patterns of the diffracting structure.

5. The method of claim 4 further comprising the step of modifying parameters associated with a model pattern producing a close match simulated diffraction signal.

6. The method of claim 4 wherein obtaining a diffraction signature of the diffracting structure on a semiconductor substrate comprises use of a radiation source-based tool.

7. The method of claim 6, wherein the radiation source-based tool comprises a light source-based tool.

8. The method of claim 7, wherein the light source-based tool comprises an incident laser beam source, an optical system focusing the laser beam and scanning through some range of incident angles, and a detector for detecting the resulting diffraction signature over the resulting measurement angles.

9. The method of claim 8, wherein the light source-based tool comprises an angle-resolved scatterometer.

10. The method of claim 7, wherein the light source-based tool comprises a plurality of laser beam sources.

11. The method of claim 7, wherein the light source-based tool comprises an incident broad spectral light source, an optical system focusing the light and illuminating through some range of incident wavelengths, and a detector for detecting the resulting diffraction signature over the resulting measurement wavelengths.

12. The method of claim 7, wherein the light source-based tool comprises an incident light source, components for varying the amplitude and phase of the S and P polarizations, an optical system focusing the light and illuminating over some range of incident phases, and a detector for detecting the phase of the resulting diffraction signature.

13. The method of claim 4, wherein obtaining a diffraction signature of the diffracting structure on a semiconductor substrate comprises phase measurement by means of a broad spectral radiation source-based tool source, operating at a fixed angle, a variable angle Θ or a variable angle φ.

14. The method of claim 4, wherein obtaining a diffraction signature of the diffracting structure on a semiconductor substrate comprises phase measurement by means of a single wavelength radiation source-based tool source, operating at a fixed angle, a variable angle Θ or a variable angle φ.

15. The method of claim 4, wherein obtaining a diffraction signature of the diffracting structure on a semiconductor substrate comprises phase measurement by means of a multiple discrete wavelength radiation source-based tool source.

16. The method of claim 4, wherein obtaining a diffraction signature of the diffracting structure on a semiconductor substrate comprises obtaining a reflective diffraction signature.

17. The method of claim 4, wherein obtaining a diffraction signature of the diffracting structure on a semiconductor substrate comprises obtaining a transmissive diffraction signature.

18. The method of claim 4, wherein the diffraction signature of the diffracting structure is a specular order diffraction signature.

19. The method of claim 4, wherein the diffraction signature of the diffracting structure is a higher order diffraction signature.

20. The method of claim 4, wherein generating simulated diffraction signatures of members of multi-layer model patterns of the diffracting structure comprises submission to a remote computer on a computer network.

21. The method of claim 20, wherein results of the step are retrieved from or returned by the remote computer.

22. A method of determining at least one parameter associated with an undercut multi-layer diffracting structure fabricated on a semiconductor substrate, the method comprising:
specifying at least one first layer model structure with at least one second layer model structure positioned thereon and extending beyond the first layer model structure in at least one dimension to define an undercut model pattern of a diffracting structure;
generating a simulated diffraction signature from the undercut model pattern of the multi-layer diffracting structure;
obtaining a diffraction signature of the diffracting structure on a semiconductor substrate;
comparing the diffraction signature of the diffracting structure to the simulated diffraction signature of the undercut multi-layer model pattern of the diffracting structure;
utilizing regression analysis to vary at least one parameter associated with the first layer model structure or the second layer model structure of the undercut multi-layer model pattern to obtain a best match model pattern.

23. A method of inferentially measuring at least one parameter associated with an undercut multi-layer diffracting structure fabricated on a semiconductor substrate by means of a radiation-based tool, the method comprising:
specifying at least one first layer model structure with at least one second layer model structure positioned thereon and extending beyond the first layer model structure in at least one dimension to define a first undercut model pattern of a diffracting structure;
specifying at least one second undercut model pattern of a diffracting structure by varying at least one parameter associated with the first layer model structure or the second layer model structure;
generating simulated diffraction signatures from members of the undercut model patterns of the multi-layer diffracting structure;
obtaining a diffraction signature of the multi-layer diffracting structure on a semiconductor substrate by means of a radiation-based tool;
comparing the diffraction signature of the multi-layer diffracting structure to the simulated diffraction signatures of undercut multi-layer model patterns of the diffracting structure, and selecting a close match simulated diffraction signature; and
deriving at least one parameter associated with the multi-layer diffracting structure by examination of the model pattern generating a close match simulated diffraction signature.

24. The method of claim 23 further comprising the step of modifying one or more parameters associated with a model pattern producing a close match simulated diffraction signature, and comparing the simulated diffraction signature thereof to the diffraction signature of the diffracting structure.
